(19) United States
(12) Patent Application Publication
(10) Pub. No.: US 2003/0176971 A1
(43) Pub. Date: Sep. 18, 2003

(54) Method and system for tracking the exchange of ballast water

(76) Inventors: John James Daniels, Higganum, CT (US); James Francis Cavadini, North Haven, CT (US)

Correspondence Address: John J. Daniels, Esq., 511 Foot Hills Road, Higganum, CT, 06441, US

(21) Appl. No.: 10/195,456

(22) Filed: Jul. 16, 2002

Related U.S. Application Data
(60) Provisional application No. 60/363,757, filed on Mar. 13, 2002.

(51) Int. Cl. G06F 19/00

(52) U.S. Cl. 702/2

(57) ABSTRACT

The water in the ballast tanks of ships is a major source for introducing aquatic nuisance species (ANS) into the inland waterways of the US. Exchange of ballast water in the open ocean has been determined to be the best available means to reduce such introduction. The present invention utilizes the automatic detection of a change in parameters such as pump activity and ballast water chemistry as indicators of when and where ballast water exchange has been completed, indicating compliance with governmental guidelines or regulations. A pump activation sensor, flow meter or volume indicator determines when ballast water movement into and out of a ballast tank occurs. A chemical composition probe automatically determines the chemical composition of the ballast water. During the ballast water exchange procedure, an onboard indicator alerts when the chemical composition is equal to that of the open ocean. Geographic location of the ship is automatically determined using a self-contained GPS system. A set of data of the chemical composition and location and other relevant data is collected and stored for later transmission to a centralized Internet server. Upon entering a US port (or any appropriate time using a satellite data connection, the stored data is automatically transmitted and uploaded to the server using existing communication infrastructure. The appropriate governmental body, i.e. the USCG, can easily and securely access a record of this ballast water exchange.

### CROSS REFERENCE TO RELATED DOCUMENTS

The present invention is the US Utility application based on Provisional Application Serial No. 60/363,757 filed Mar. 13, 2002 and relates to an invention described in a Disclosure Document No. 507614 filed with the United States Patent and Trademark Office.

### BACKGROUND OF THE INVENTION

The present invention pertains to a ballast water exchange monitoring system. More particularly, the present invention pertains to a method and system for tracking the chemistry of ballast water within ships entering inland or coastal bodies of water from the open ocean.

As noted in a recent Small Business Innovation (SBIR) solicitation (see, DTRS57-02-R-SBIR, U.S. Department of Transportation, Office of the Secretary of Transportation), ballast water discharged from ships has been implicated as a major means for introducing non-indigenous aquatic nuisance species (ANS) to the aquatic ecosystems of the United States. In an effort to reduce risk of such introductions, Congress enacted regulations that now include the procedure of mid-ocean ballast water exchange. Most ANS are either fresh or brackish water organisms that cannot survive in high salinity environments found in the open ocean.

Ships travel to the US from all parts of the globe. The ballast water of these ships has been determined to be the largest source for introduction of problematic ANS into US waters. Every year these ANS are wreaking tremendous economic and ecological damage. As noted at the website www.massbay.mit.edu/exoticspecies/ballast/, scientists estimate as many as 3,000 species per day are transported in the ballast tanks of ships around the world.

As one example, zebra mussels have infested the Great Lakes, Mississippi River drainage waters, Arkansas River, Hudson River and Lake Champlain. This invasion, like most, has disrupted the diversity and abundance of native fish and other species. Other examples of ANS include the mitten crab infestation of the Pacific Coast; the green crab infestation of the Atlantic Ocean; and the brown mussel infestation of the Gulf of Mexico. Aquatic nuisance vegetation species, such as Eurasian watermilfoil, hydrilla, water hyacinth and water chestnut have been introduced into US waters through ballast tank discharge. If preventive management measures are not taken nation wide, further introductions and infestations of species as destructive, or even more destructive, than the current ANS may occur (see, National Invasive Species Act of 1996).

The environmental and economic impact of ANS is a world wide problem. Last year many of the world's industrialized countries participated in the International Maritime Organization's (IMO) convention on the ballast water/ANS problems. It was determined that ballast water exchange would be one of the “toolbox” of options permitted (see, IMO MARINE ENVIRONMENT PROTECTION COMMITTEE, HARMFUL AQUATIC ORGANISMS IN BALLAST WATER, Report of the Ballast Water Working Group convened during MEPC 46, MEPC 47/2, Nov. 30, 2001). The results of Brazil's investigation of ballast water exchange reveal that in relation to ballast water management, 69% of the ships sampled stated to have carried out ballast water exchange and 19% stated to have done some type of ballast water treatment. However, salinity tests performed in a laboratory on water samples from the ships' ballast tanks, combined with the taxonomic information, indicate that most (95%) of the reported ballast exchange procedures were not performed at the open sea or, alternatively, involved only partial exchange (see, IMO MARINE ENVIRONMENT PROTECTION COMMITTEE, HARMFUL AQUATIC ORGANISMS IN BALLAST WATER, Investigation carried out in selected ports in Brazil to identify and characterize pathogens in ballast water, MEPC 47/2/11, Dec. 21, 2001). Clearly, there is a need for an effective monitoring system to ensure that adequate ballast water exchange is being performed by ships.

A solution for reducing the level of ANS released into coastal and inland waterways is to require ships to exchange their ballast water while out at sea. Ballast water exchange effectively helps eliminate ANS by (1) discharging a percentage of coastal/freshwater organisms into the inhospitable environment of the ocean and (2) exchanging coastal/freshwater organisms for mid-ocean organisms, which are not expected to survive when subsequently released into coastal/freshwater areas. Additionally, the exchange increases the salinity level within the ballast water tank such that remaining coastal/freshwater organisms have a reduced chance of survival.

The problem of the spreading of harmful aquatic organisms in ships' ballast water and sediments needs urgent international action. A proper response to the problem can only be achieved through an international convention in force. The chance of having a ballast water convention rapidly taking effect is higher if the requirements of the convention give the needed environmental protection as well as the possibility for shipping to operate safely and efficiently (see, IMO MARINE ENVIRONMENT PROTECTION COMMITTEE, HARMFUL AQUATIC ORGANISMS IN BALLAST WATER, Proposal for elements to be included in the two-tier approach, MEPC 47/2/8, Dec. 28, 2001). There is also a need to track coastal shipping operations and ballast management practices of shipts that run up and down a coast and become a source of domestic ANS invasions.

Most ANS are either fresh water or brackish water organisms that cannot survive in high salinity environments found in the open-ocean. In an effort to reduce risk of such introductions, Congress passed guidelines that now include the procedure of mid-ocean ballast water exchange (see, Voluntary guidelines for ballast exchange CFR151.2035b, Law regarding filing of ballast exchange form CFR151.2045, ruling defining exchange CFR151.2025). Ballast exchange is an ecologically friendly and low cost method for killing off ANS, but requires ships to perform this operation at sea without supervision. Monitoring is necessary to enforce compliance with ballast exchange laws. An ideal monitoring system will facilitate monitoring by a governmental agency, while at the same time reduce the shipper's burden in compliance.

Two methods of ballast water exchange are conventionally used. The first is an “empty-refill” method, where a ballast tank is emptied to its lowest level and then refilled with open ocean water. The second method is described as a “flow-through” method, where three tank volumes are pumped through a given ballast water tank, while simultaneously allowing the tank to overflow through an installed discharge.

However, an effective monitoring system is needed to verify that ballast water exchange has indeed been accomplished, either by empty-refill or flow-through method. One potential system suggested by the SBIR solicitation would automatically monitor and record ballast water tank levels, and in addition would link tank levels to the ship's geographical position. The solicitation suggests that this monitoring system would be “add-on” equipment to an existing tank level indicating system, providing an electronic and/or paper record of ballast water tank levels and ship positions along the course of any given voyage.

The geographical location of the ballast water exchange is vital to confirm that exchange took place outside the 200 nautical mile Exclusive Economic Zone, as regulations state. The SBIR solicitation suggests that the system activate only when changes in tank levels are detected, or when a ballast water pump or flow switch is energized. Verification of ballast water exchange using the empty-refill method would be shown by a sequential recording of full/empty/full tank levels. The SBIR solicitation suggests that verification of ballast water exchange using the flow-through method would be shown by a 100% full (in fact—overflowing) tank level for a period of time needed to deliver three tank volumes based on pumping rate.

Many benefits are derived from a system that enables a governmental agency, such as the Coast Guard, to effectively and efficiently monitor the ballast water exchange of ships entering US waters. The primary benefit is the reduction in the number of unwanted organisms' that are released into fresh water and coastal waterways. Reducing ANS introductions will slow the rate at which unwanted non-native species spread throughout the US and the world's aquatic ecosystem, thus reducing the tremendous environmental and ecological costs.

However, a system such as that described by the SBIR solicitation would suffer numerous drawbacks. The system would have to be installable on a wide variety of ships, making it troublesome to retrofit to an existing electrical system to detect when a ballast water pump or flow switch is energize. The number of potential onboard electrical systems of various boat types by various boat manufacturers makes such a retrofit difficult. Many ships have multiple ballast tanks. Detecting the flow rate of ballast water within each tank is difficult as well, as is monitoring each tank level. For the system to fulfill its intended purpose, the data collected must be stored and somehow transmitted to authorities for verification. To be effective, the ballast water content of many ocean going ships must be simultaneously tracked as they enter the coastal regions. The authorities have to access the information, and keep track of the collected data from a very large number of ships. Paper records are difficult to maintain and collect into a centralized database. To be an effective solution, a ballast water data collection system should require little if any human intervention to operate, and not require the manual collection of data and generation of a paper record.

### SUMMARY OF THE INVENTION

The present invention overcomes the drawbacks of the conventional art. It has been conclusively determined that creating a relatively high concentration of salt by exchanging ballast water in the open ocean is an effective mechanism for killing off unwanted fresh water ANS contained within the tank. However, the mechanisms suggested for keeping track of the exchange of the water in the ballast tanks are difficult to employ. The present invention overcomes these difficulties by directly monitoring the change in the chemical composition of the ballast water. In a preferred embodiment, the chemical composition change that is monitored is the water salinity. It is therefore an object of the present invention to provide a method and system for tracking the chemistry of ballast water.

The present invention provides a solution to the need for monitoring the exchange of ballast water in the tanks of ships entering US coastal water. An effective way of reducing the level of ANS released into coastal and inland waterways is to require ships to exchange their ballast water while out at sea. Ballast water exchange effectively helps eliminate ANS by discharging the unwanted organisms into the inhospitable environment of the ocean. Exchanging ballast water in the open-ocean also results in exchanging coastal/freshwater organisms for mid-ocean organisms, which are not expected to survive when subsequently released into the fresh water areas. Additionally, the exchange increases the salinity level within the ballast water tank such that remaining coastal/freshwater organisms have a reduced chance of survival.

It is another object of the present invention to provide an effective means to enable the Coast Guard to monitor the ballast water exchange of ships entering coastal US waters from the open-ocean.

In accordance with the present invention, the chemistry of ballast water in the ballast water tank of a ship is tracked and made available to authorities. In the preferred embodiment of the invention, the salt content of ballast water contained within a ballast water tank of a ship is detected. When a change in chemistry of the ballast water exceeding a predetermined threshold is detected, the geographic location of the ship is determined. A set of data is generated and stored dependent on the determined change in chemistry and the determined geographic location. In practice, this change in chemistry is expected to occur, for example, outside of a 200 mile range from the coast. The change in chemistry occurs when the ballast water contained within the ballast water tank is exchanged for open sea water, as may be done in compliance with a government regulation. Therefore, the data set regarding the change in chemistry and the location of the ship during the change may be stored for later transmission to a centralized data collection device, such as a computer server connected to the Internet. Alternatively, the data may be automatically transmitted at the time or relatively shortly after it is collected. In any case, the data set is transmitted to the centralized data collection device. Thus, the change in chemistry of ballast water within the ballast tank of the ship can be tracked and a record of the change in chemistry and the geographic location of the ship during the change can be uploaded to the data collection device.

The salt content of ballast water can be detected using a chemistry probe. In accordance with an embodiment of the present invention, the chemistry probe consists of a pair of electrodes that are inserted in the ballast water. A current change detector detects the change in chemistry dependent on the change in current flow through the ballast water between the pair of electrodes. Of course, other changes can be detected, or another type of test made to determine the change in the salinity or chemical composition of the water within the tank. The geographic location can be determined using a GPS system. The GPS signal can come from an already existing onboard navigation system. However, to create a more tamper-proof, more robust and less intrusive system, a self-contained, dedicated GPS system can be incorporated into the inventive system. Alternatively, other positioning system can be utilized where available. Typically, ballast tanks are located deep within a ship's hull. If necessary, the GPS system or at least the GPS antenna can be located topside of the ship so that the antenna receives signals from the GPS satellites.

The data collected regarding the chemistry and location can be transmitted via radio transmitter to a centralized data collection device, such as an Internet server. For example, a satellite telephone, or short wave radio, can be used to transmit the collected data from nearly anywhere. Or, a more localized radio system, such as a cellular telephone or other wireless transmission system can be employed. In the case of a cellular telephone, for example, the inventive system can be constructed so that the stored data is automatically uploaded upon detecting the appropriate range from a cellular receiving station. Further, if desirable, the location of the cellular receiving station might be used to track the port or entry point of the ship into the coastal region. Alternatively, the GPS system may also be used to determine the port or entry point.

This data, along with the collected data pertaining to the chemistry and the location of the ship during the chemistry change can be formatted in any appropriate manner. As an example, the data can be automatically formatted into HTML data using, for example, a PIC web server microprocessor or a general purpose computing device. This HTML data can then be uploaded over the Internet to a centralized server. Encryption and password protection, as well as other security measures, may be employed as necessary to keep the collected data reliable and secure. This data can contain all manner of useful information

A satellite radio transmitter can be used for transmitting the stored data at predetermined times, or in response to the determined change in chemistry reaching the predetermined threshold level. A radio transmitter, like a cellular telephone, can be used for automatically transmitting the stored data when the geographic location of the ship reaches a predetermined location. For example, the cellular telephone may include a signal range detector for detecting when the ship is within transmission range of a receiver for uploading the stored data. Thus, as a nearly ubiquitous and easily constructed implementation of the present invention, a cellular telephone system can be used for automatically uploading the stored data when the ship comes with signal range of a cellular phone signal receiving station.

The collected and stored data can be formatted for transmission over the Internet, and wirelessly transmitted via a cellular telephone modem, and a data collection device comprising a remotely located Internet server used to organize and disseminate the chemistry tracking data collected from a large number of ships. A dedicated PIC-based web server device, or other mechanism, may be employed for converting the collected data into Internet formatted stored data uploaded from the ship via an Internet connection.

To lessen the possibility of tampering with data or improper or unwanted access to vital or private ship information, the Internet formatted stored data can be organized and disseminated from a Internet web site stored on a dedicated computer internet server located, for example, at a secured location and under the control of an appropriate government agency.

### BRIEF DESCRIPTION OF THE DRAWINGS

FIG. 1 is a block diagram illustrating an embodiment of the inventive system for tracking the chemistry of ballast water in the ballast water tank of a ship;

FIG. 2 is a block diagram illustrating the components of a salinity probe and current change detector in accordance with an embodiment of the present invention;

FIG. 3 is a flow chart showing the steps of collecting data related to the ballast water chemistry and the location of the ship;

FIG. 4 is a flow chart showing the steps for transmitting the collected data to a data collection center;

FIG. 5 is an illustration showing the operation of the inventive system for tracking the chemistry of ballast water in the ballast water tank of a ship;

FIG. 6 is flow chart showing the use of the present invention for determining the completeness of a ballast exchange based on a combination of detected indicators including such things as chemical components in the ballast water including metals, salts, organic materials and radiation, and operational parameter including pump activity, water flow detection into and/or out of a ballast tank, tank volume, etc.;

FIG. 7 is a circuit diagram showing an embodiment of the inventive chemical composition probe for detecting the change in the chemical properties of ballast water during an open ocean ballast exchange;

FIG. 8 is a block diagram showing a chemical probe for use in detecting trace amounts of potentially deleterious chemical indicators present in the ballast water of a ship;

FIG. 9 is a schematic view of an inventive ballast water chemical probe magnetically fixed to the interior wall of a ballast tank of a ship;

FIG. 10 is a schematic view of components of the inventive ballast monitoring system including a removable, magnetically fixed ballast water chemical probe and detector fixed on the interior of a ballast water tank and a wireless signal transmitter in communication with the detector and fixed to the exterior of the ballast tank;

FIG. 11 is a block diagram and schematic view of a centralized data collection and device control system in wireless communication with remotely located multiple ballast tank monitoring components;

FIG. 12 is a schematic view of a wireless signal transmitter and power coupler fixed to the exterior of a ballast water tank and a rechargable power supply and chemical probe detector fixed to the interiour of the ballast water tank, wherein the rechargeable power supply receives electrical energy generated by the power coupler and transmitted through the wall of the ballast water tank in the form of a varying magnetic field;

FIG. 13 is a schematic view of a wired signal transmitted fixed to the exterior of the ballast water tank and a chemical probe detector fixed to the interior of the ballast water tank, wherein the data collected by the chemical probe detector and control signals are communicated to and from a centralized data collection and device control system via electrical signals injected onto the existing ship electrical powerlines;

FIG. 14 is a block diagram showing a prototype ballast monitoring system constructed in accordance with the present invention;

FIG. 15 is a screen print of the windows of the prototype software showing the user interface indicating the status of each of the ballast tanks, the detection of salinity as a chemical parameter indicating an exchange of fresh water ballast water for open ocean water; and details of one of the ship's ballast tanks;

FIG. 16 is a screen print of the windows of the prototype software showing the user interface indicating the status of each of the ballast tanks, and the shipping information and ballast history of one of the ship's ballast tanks;

FIG. 17 is a screen print of the windows of the prototype software showing the user interface indicating the ship details to be included in the submission of a reporting form, the detection of metals, organic and isotopes as chemical parameters indicating an exchange of coastal water ballast water for open ocean water; and an HTML form document automatically filled out with the required ship, voyage and ballast information and submitted via the Internet to an Internet server to become part of a database; and

FIG. 18 is a screen print of the windows of the prototype software showing a GPS determined location of the ballast exchange on a world map and the tank history of one of the ballast tanks of a ship.

### DETAILED DESCRIPTION OF THE INVENTION

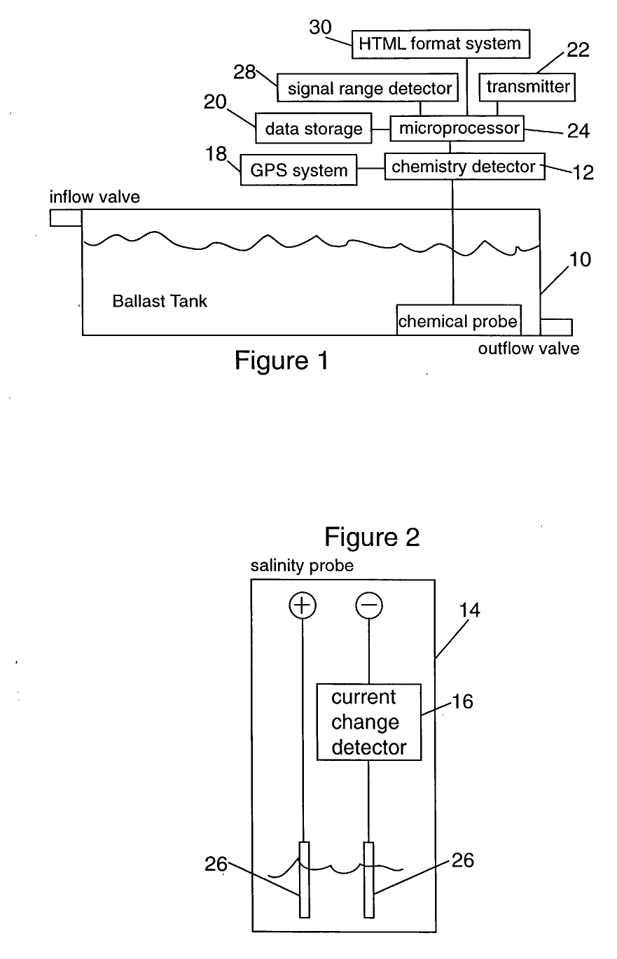

The present invention provides a system for tracking the chemistry of ballast water in the ballast water tank 10 of a ship. FIG. 1 is a block diagram illustrating an embodiment of the inventive system for tracking the chemistry of ballast water in the ballast water tank 10 of a ship. A chemistry detector 12 detects the salt content of ballast water contained within a ballast water tank 10 of a ship. Chemistry change determining means (for example, a microprocessor connected to the chemistry (e.g., salinity) probe 14 and the current change detector 16 shown in FIG. 2) determines a change in chemistry of the ballast water. Geographic location determining means 18 determines a geographic location of the ship when the determined change in chemistry reaches a predetermined threshold level. Storage means 20 stores data dependent on the determined change in chemistry and the determined geographic location. Uploading means 22 uploads the stored data to a remote data collection device. Controlling means 24, such as a microprocessor, is provided for receiving a signal from the chemistry change determining means indicating the change in chemistry. The controlling means 24 controls the geographic location determining means 18 and the storing means so that the change in chemistry of ballast water within the ballast tank 10 of the ship can be tracked. The controlling means 24 also controls the uploading means 22 so that a record of the change in chemistry and the geographic location of the ship during the change can be uploaded to the data collection device.

FIG. 2 is a block diagram illustrating the components of a chemistry probe 14 and current change detector 16 in accordance with an embodiment of the present invention. The chemistry detector 12 includes a salinity probe 14 comprising a pair of electrodes 26 that can be inserted in the ballast water. The electrodes 26 can be easily retrofitted to an existing ballast tank 10. In accordance with an embodiment of the present invention, the electrodes 26 and wire leads connected to them are the only elements that need to be retrofitted with an existing ballast tank 10, making the inventive system an easy to install and robust solution to the ANS ballast tank 10 problem. A current change detector 16 detects the change in salinity dependent on the change in current flow through the ballast water between the pair of electrodes 26. For example, when the fresh water contained within the ballast tank 10 is exchanged for open-ocean salt water, the current flow through the ballast water will increase in proportion to the increase of salt concentration.

As shown in FIG. 1, existing enabling technology allows the inventive system to be relatively low cost and easily implemented. For example, the geographic location determining means 18 may comprise a commercially available GPS system for determining the geographic location of the ship. The storage means 20 comprises a random access memory device, and may be part of a commercially available computer device such as a personal data assistant or hand-held computer. The uploading means 22 comprises a radio transmitter for transmitting the stored data. A satellite radio transmitter may be employed for transmitting the stored data at predetermined times and/or in response to the determined change in salinity reaching the predetermined threshold level. Alternatively, the uploading means 22 may comprise a radio transmitter for transmitting the stored data when the geographic location of the ship reaches a predetermined determined location. A signal range detector 28 may be used for detecting when the ship is within transmission range of a receiver for uploading the stored data. For example, the uploading means 22 may a cellular telephone, and the receiver comprises a cellular phone signal receiving station. The uploading means 22 may also include an HTML format system 30 for formatting the stored data for transmission over the Internet, and the data collection device may be a remotely located Internet server.

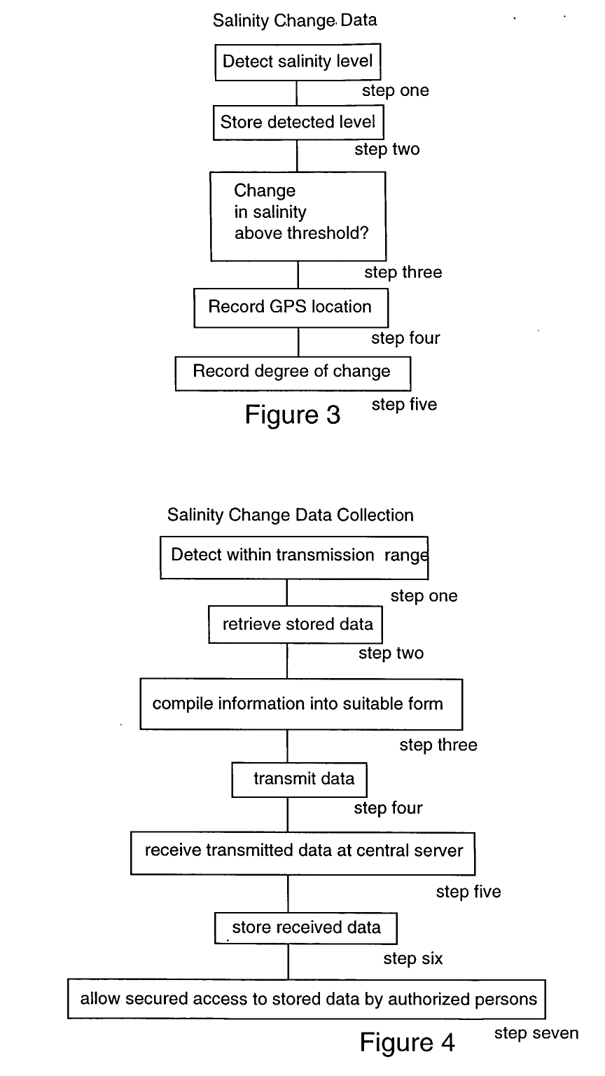

FIG. 3 is a flow chart showing the steps of collecting data related to the ballast water chemistry and the location of the ship. In accordance with the present invention, the chemistry of ballast water in the ballast water tank 10 of a ship is tracked and made available to authorities. The salt content of ballast water contained within a ballast water tank 10 of a ship is detected (step one). The detected level is stored (step two). If a change in chemistry of the ballast water exceeding a predetermined threshold is detected (step three), the geographic location of the ship is determined and a set of data is generated and stored dependent on the determined change in chemistry and the determined geographic location (steps four and five).

In practice, this change in chemistry is expected to occur, for example, outside of a 200-mile range from the coast. The change in chemistry occurs when the ballast water contained within the ballast water tank 10 is exchanged for open seawater, as may be done in compliance with a government regulation. Therefore, the data set regarding the change in chemistry and the location of the ship during the change may be stored for later transmission to a centralized data collection device, such as a computer server. Alternatively, the data may be automatically transmitted at the same time or relatively shortly after it is collected. In any case, the data set is transmitted to the centralized data collection device so that multiple ships can be simultaneously and easily tracked. Thus, the change in chemistry of ballast water within the ballast tank 10 of the ship can be tracked and a record of the change in chemistry and the geographic location of the ship during the change can be uploaded to the data collection device.

As shown in FIG. 2, the salt content of ballast water can be detected using a salinity probe 14. In accordance with an embodiment of the present invention, the salinity probe 14 consists of a pair of electrodes 26 that are inserted in the ballast water. A current change detector 16 detects the change in chemistry dependent on the change in current flow through the ballast water between the pair of electrodes 26. Of course, a voltage changed can be detected, or another type of test made to determine the change in the chemistry within the tank 10. As shown in FIG. 1, the geographic location can be determined using a GPS system. The GPS signal can come from an already existing onboard navigation system. However, to create a more tamper-proof and/or less intrusive system, a self-contained, dedicated GPS system can be incorporated into the inventive system.

The data collected regarding the chemistry and location can be transmitted via radio transmitter. For example, a satellite telephone, or short wave radio, can be used to transmit the collected data from nearly anywhere. Or, a more localized radio system, such as a cellular telephone or other wireless transmission system can be employed. In the case of a cellular telephone for example, the inventive system can be constructed so that the stored data is automatically uploaded upon detecting the appropriate range from a cellular receiving station. Further, the location of the cellular receiving station might be used to track the port or entry point of the ship into the coastal region. Alternatively, the GPS system may also be used to determine the port or entry point.

This data, along with the collected data pertaining to the chemistry of the ballast water and the location of the ship during the chemistry change can be formatted in any appropriate manner. As an example, the data can be automatically formatted into HTML data using, for example, a PIC web server microprocessor or a general purpose computing device. This HTML data can then be uploaded over the Internet to a centralized server. Encryption and password protection, as well as other security measures, may be employed as necessary to keep the collected data reliable and secure.

A satellite radio transmitter can be used for transmitting the stored data at predetermined times or in response to the determined change in chemistry reaching the predetermined threshold level. A radio transmitter, like a cellular telephone, can be used for automatically transmitting the stored data when the geographic location of the ship reaches a predetermined location. For example, the cellular telephone may include a signal range detector 28 for detecting when the ship is within transmission range of a receiver for uploading the stored data. Thus, as a nearly ubiquitous and easily constructed implementation of the present invention, a cellular telephone system can be used for automatically uploading the stored data when the ship comes within signal range of a cellular phone signal receiving station.

The collected and stored data can be formatted for transmission over the Internet, and wirelessly transmitted via a cellular or satellite telephone modem, and a data collection device comprising a remotely located Internet server used to organize and disseminate the chemistry tracking data collected from a large number of ships. A dedicated PIC-based web server device, or other mechanism, may be employed for converting the collected data into Internet formatted stored data prior to being uploaded from the ship via an Internet connection.

To lessen the possibility of tampering with data or improper or unwanted access to the ship information, the Internet formatted stored data can be collected, organized and disseminated via a virtual private network from a Internet web site hosted on a dedicated computer internet server located, for example at a secured location and under the control of an appropriate government agency.

FIG. 4 is a flow chart showing the steps for transmitting the collected data to a data collection center. In accordance with the embodiment of the invention that utilizes, for example, a cellular telephone transmitter, the transmission range of the transmitter is detected by receiving, for example, a transmission signal from a ground-based cellular telephone station (step one). The data pertaining to chemistry and location gathered during the ships voyage is retrieved from storage (step two) and the information contained within the data is compiled into suitable form (step three). For example, the information can be automatically compiled into an HTML table format, a spreadsheet (such as Microsoft's Excel), or other suitable data form. The data is transmitted (step four) from the ship and received via, for example, the Internet, by a central server (step five). The received data is stored on the central server (step six) where it can be retrieved only using secured access by authorized persons (step seven).

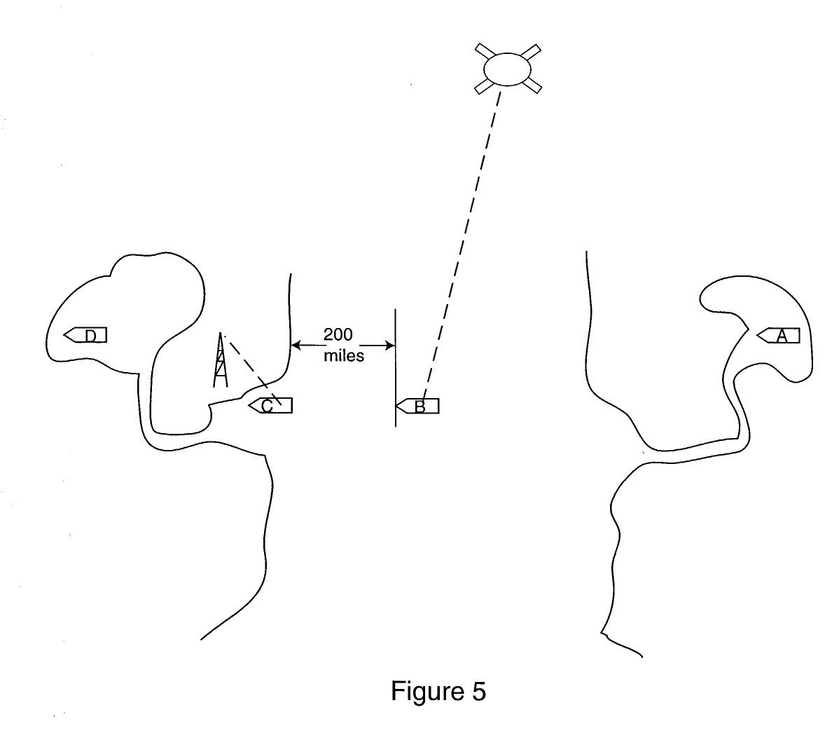

FIG. 5 is an illustration showing the operation of the inventive system for tracking the chemistry of ballast water in the ballast water tank 10 of a ship. A ship begins a transoceanic journey from a fresh water port (ship position A). At this fresh water port, ballast water is taken on which may include unwanted organisms, or ANS. The ship crosses the ocean and arrives at a location where the fresh water within the ballast tank 10 is to be exchanged for open-ocean water. This open-ocean water has a salt content that is effective for killing off the ANS that has traveled along with the ship within the ship's ballast tanks 10. As the ballast water is exchanged, the salt content of ballast water contained within the ballast water tank 10 of a ship is detected. When the change in chemistry of the ballast water exceeds a predetermined threshold, that is when chemistry has reached the level desired for killing off the ANS or reaches some proportion of the chemistry of the open-ocean water, the geographic location of the ship is determined using signals received from a GPS satellite system. In accordance with government regulations, for example, this exchange is to occur outside the 200-mile coastal range, as illustrated by ship position B.

A set of data is generated and stored dependent on the determined change in chemistry and the determined geographic location. The data set regarding the change in chemistry and the location of the ship during the change is stored for later transmission to a centralized data collection device, such as a computer server. Upon coming close to the coast and/or entering a port, the ship comes within range of a cellular telephone receiver (as illustrated by ship position c) and uploads the stored data via the cellular telephone link. This data is transmitted over the Internet and collected on an Internet server. Thus, the change in chemistry of ballast water within the ballast tank 10 of the ship can be tracked and a record of the change in chemistry and the geographic location of the ship during the change can be uploaded to the data collection device. The ship may then progress on to freshwater bodies of water with the unwanted ANS organisms within it ballast tank 10s killed off by the open-ocean salt water (ship position D).

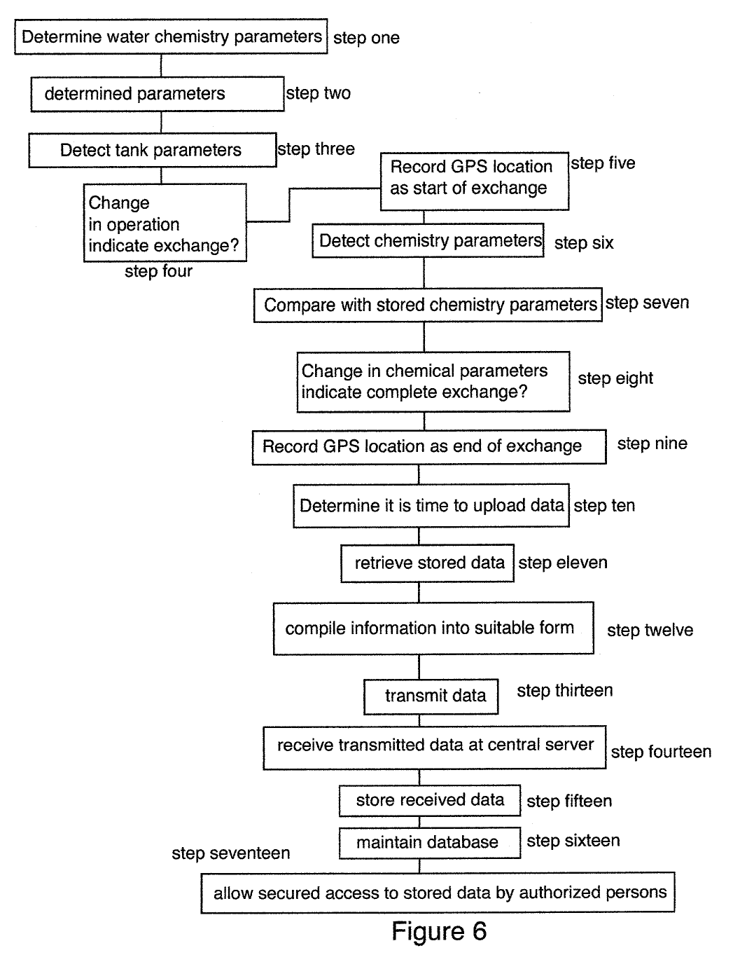

FIG. 6 is flow chart showing the use of the present invention for determining the completeness of a ballast exchange based on a combination of detected indicators including such things as chemical components in the ballast water including metals, salts, organic materials and radiation, and operational parameter including pump activity, water flow detection into and/or out of a ballast tank, tank volume, etc. The water chemistry is an important indicator of the contents within a ballast tank. It is known that open ocean water and coastal water differ in the concentrations of a number of chemicals. For example, tbe chemistry of coastal water is influenced by land run off and contains amounts of metals, organic materials and isotopes, such as radium, in concentrations that are different from that of open ocean water. Thus, the detection of these parameters can be used to determine when a ballast tank contains open ocean water and even the percentage of open ocean water within the tank. Further, during a voyage a ship may exchange the ballast water in a ballast tank at intervals, rather than all at once. Thus, simply detecting the activation of a pump may not provide data which is a true indication of the tank contents (and thus the completeness of an exchange). The present invention utilizes a combination of detected parameters to give a clearer indication of the completeness of a ballast exchange in compliance with and adaptable to evolving regulations. FIG. 6 is a flowchart illustrating the inventive use of multiple detected parameters for indicating the completeness of a ballast exchange and the location that the exchange occurs.

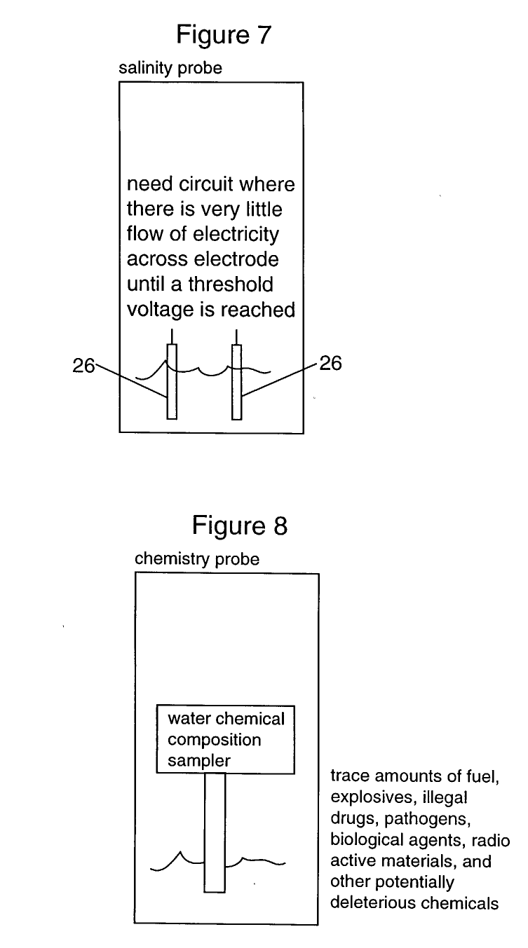

FIG. 7 is a circuit diagram showing an embodiment of the inventive chemical composition probe for detecting the change in the chemical properties of ballast water during an open ocean ballast exchange.

FIG. 8 is a block diagram showing a chemical probe for use in detecting trace amounts of potentially deleterious chemical indicators present in the ballast water of a ship.

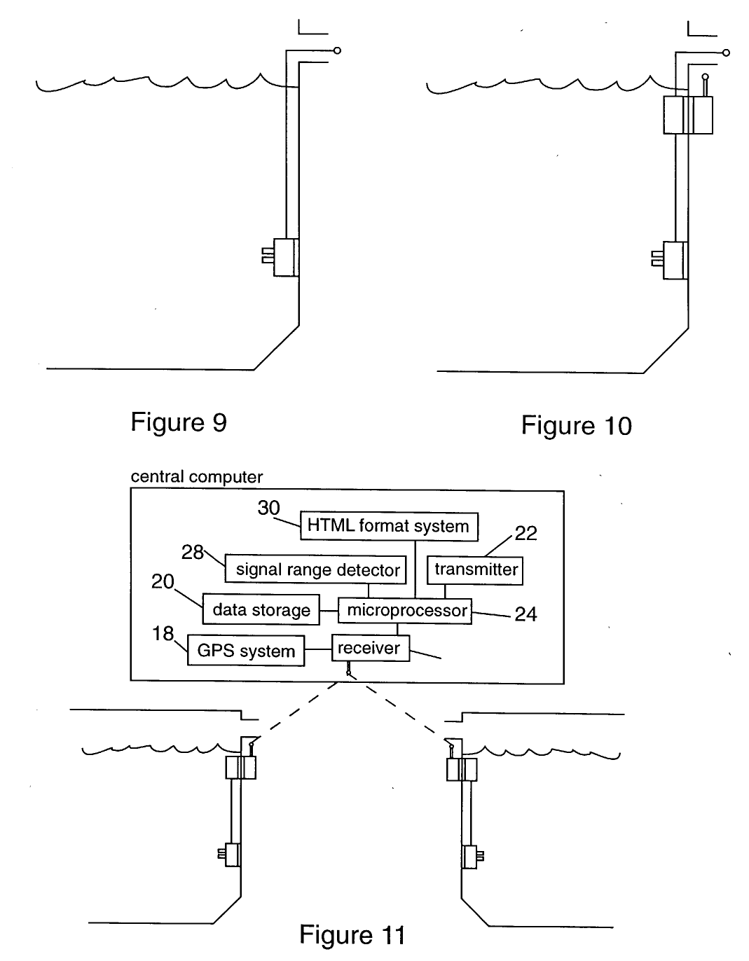

FIG. 9 is a schematic view of an inventive ballast water chemical probe magnetically fixed to the interior wall of a ballast tank of a ship.

FIG. 10 is a schematic view of components of the inventive ballast monitoring system including a removable, magnetically fixed ballast water chemical probe and detector fixed on the interior of a ballast water tank and a wireless signal transmitter in communication with the detector and fixed to the exterior of the ballast tank.

FIG. 11 is a block diagram and schematic view of a centralized data collection and device control system in wireless communication with remotely located multiple ballast tank monitoring components.

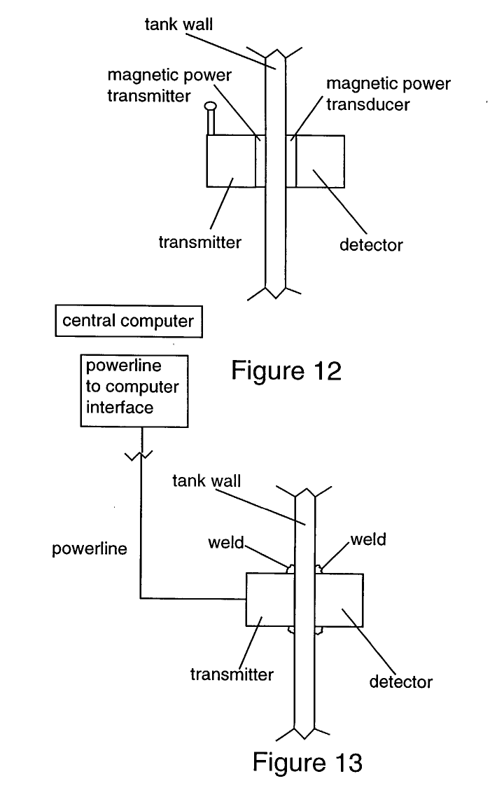

FIG. 12 is a schematic view of a wireless signal transmitter and power coupler fixed to the exterior of a ballast water tank and a rechargable power supply and chemical probe detector fixed to the interiour of the ballast water tank, wherein the rechargeable power supply receives electrical energy generated by the power coupler and transmitted through the wall of the ballast water tank in the form of a varying magnetic field.

FIG. 13 is a schematic view of a wired signal transmitted fixed to the exterior of the ballast water tank and a chemical probe detector fixed to the interior of the ballast water tank, wherein the data collected by the chemical probe detector and control signals are communicted to and from a centralized data collection and device control system via electrical signals injected onto the existing ship electrical powerlines.

The chemistry detector can be configured so that it can be used to detect other chemicals in water, include fuel, hazardous chemicals, explosives, biological agents and others to aid in the prevention of unintentional or intentional contamination of water ways by the contents in the ballast tanks of a ship. Drugs and other contraband can be detected. The present invention may also be utilized in this manner as a first line of defense against terrorists or other bad actors from using the ballast tanks of a ship in harmful ways.

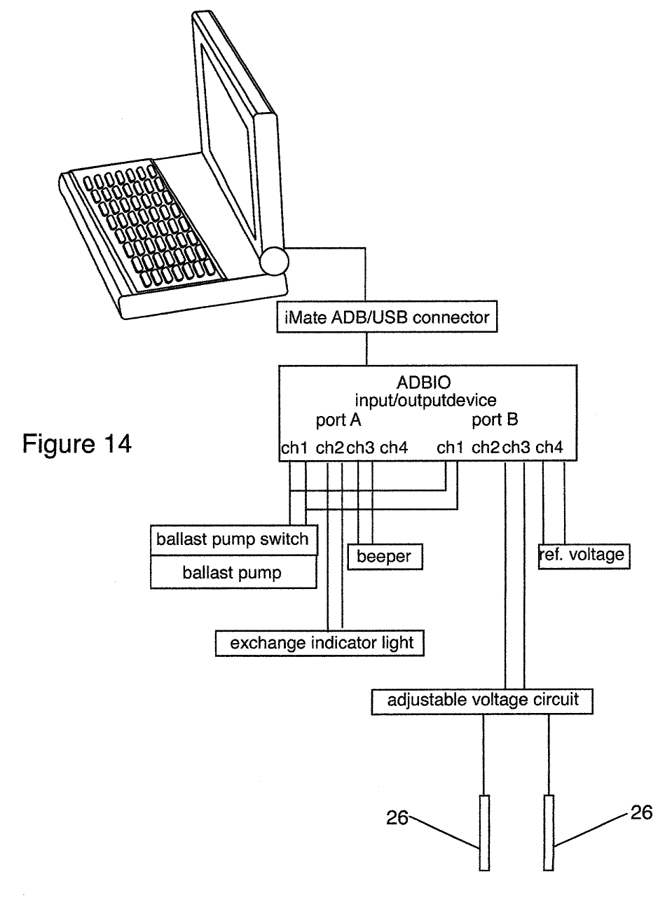

FIG. 14 is a block diagram showing a prototype ballast monitoring system constructed in accordance with the present invention. The prototype included a salinity detector circuit comprised of an adjustable voltage regulator. The variable resistance that controls the output of the adjustable voltage regulator was determined by the conductivity of water between two electrodes. Thus, the electrodes submerged in water of varying salinity resulted in a variable output from the adjustable voltage regulator. This output was received by an ADBIO input/output device connected to the computer. In practice, other chemical parameters can be checked to determine a difference between the ballast water and the open-ocean water. The chemical parameters include, for example, metals, isotopes (e.g., radium), organic materials (e.g., lignin), and/or other chemical variables that can be used to determine when water in a ballast tank has been exchanged with open-ocean water.

In the prototype, an ADBIO is used as the input/output device connected to the computer for receiving chemistry parameters, such as salinity, metals, organic material, isotopes, etc., and determining the chemical composition of the water within each ballast tank of a ship

GPS data can be received from a self-contained unit (with an antenna open to the sky) or from the output of one of the ship's existing GPS systems

the Tank Details include specifics related to each of the ballast tanks subject to monitoring. The tank details include water chemistry, volume, pump activity, flow rate, etc. Also included are values determined depending on the GPS data and the tank data to indicate to the ship crew information such as a window of opportunity to comply with a full ballast exchange, etc.

In accordance with the present invention, the monitoring of ballast exchange may include providing a ship crew with data that assists in the compliance of ballast exchange regulations. The prototype software simulates a window of opportunity calculated based on the tank contents. In practice, the window of opportunity will be calculated on-the-fly based on information such as pump efficiency history, tank volume, flow rates and pumping intervals. If the system notices a drop in a particular pump's efficiency, a maintenance signal can be transmitted to the crew and to the ship owner or agent. The compliance of a full exchange is indicated by factors such as water chemistry, volume of water that flows through tank, etc. Two or more factors can be used to increase consistency and correctness of the determination of a complete exchange.

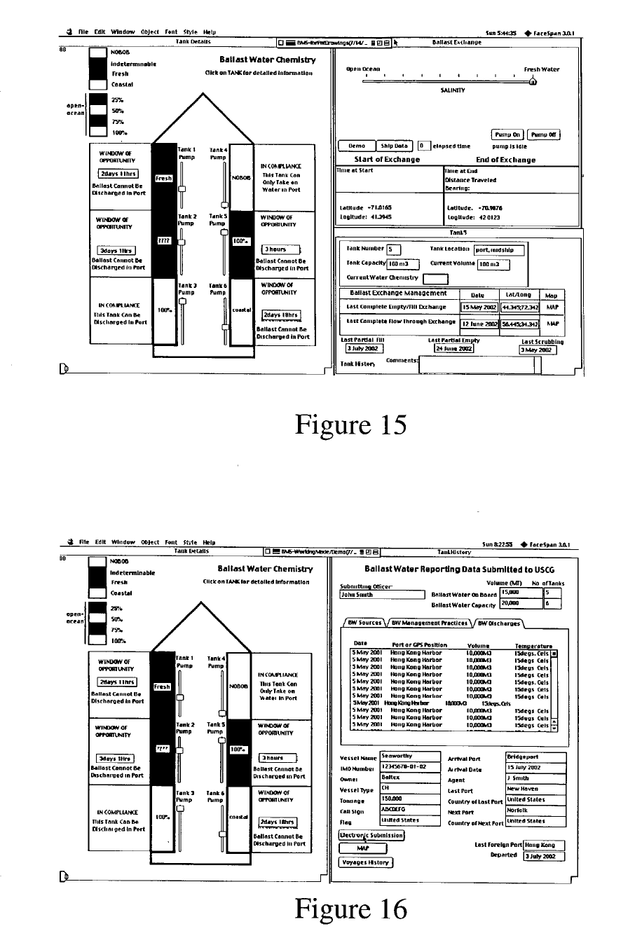

FIG. 15 is a screen print of the windows of the prototype software showing the user interface indicating the status of each of the ballast tanks, the detection of salinity as a chemical parameter indicating an exchange of fresh water ballast water for open ocean water; and details of one of the ship's ballast tanks;

FIG. 16 is a screen print of the windows of the prototype software showing the user interface indicating the status of each of the ballast tanks, and the shipping information and ballast history of one of the ship's ballast tanks;

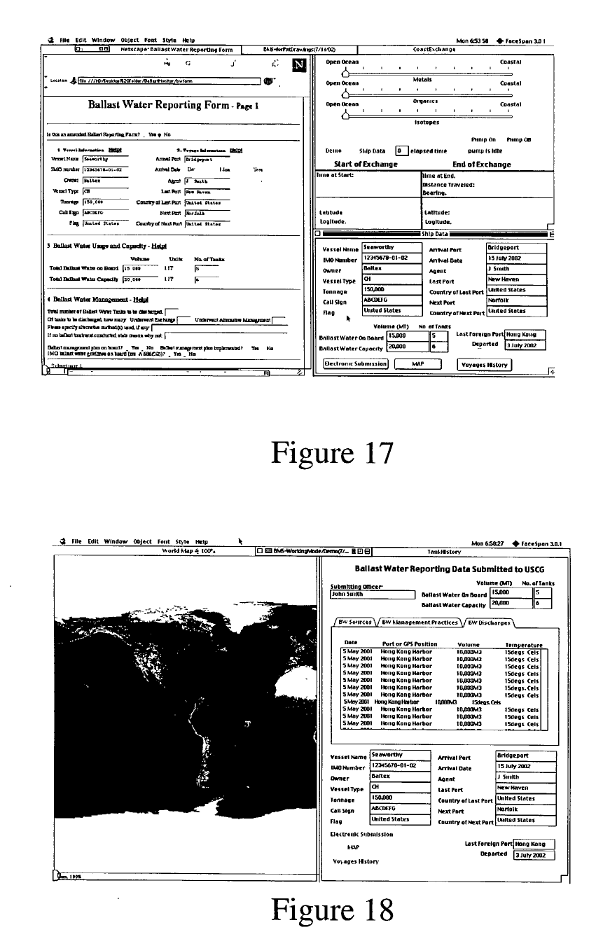

FIG. 17 is a screen print of the windows of the prototype software showing the user interface indicating the ship details to be included in the submission of a reporting form, the detection of metals, organic and isotopes as chemical parameters indicating an exchange of coastal water ballast water for open ocean water; and an HTML form document automatically filled out with the required ship, voyage and ballast information and submitted via the Internet to an Internet server to become part of a database; and

FIG. 18 is a screen print of the windows of the prototype software showing a GPS determined location of the ballast exchange on a world map and the tank history of one of the ballast tanks of a ship.

The folowing is code from Prototype Software written using FaceSpan™ for a Macintosh Computer.

This is the Application code that initializes the computer interface:

```
on run --this application demonstrates Baltech, LLC's Automatic Ballast
Exchange Monitoring System
--ADBIO is the input/output device connected to the computer for
receiving chemistry parameters, such as salinity, metals, organic material,
isotopes, etc., and determining the chemical composition of the water
within each ballast tank of a ship
configure ADBIO unit 1 port A as {digital out, digital out, digital out,
digital out}
configure ADBIO unit 1 port B as {analog in, analog in, analog in, analog
ref}
--GPS data can be received from a self-contained unit (with an
antenna open to the sky) or from the output of one of the ship's existing
GPS systems open window “GPS DATA”
set position of window “GPS DATA” to {612, 458}
    --the Tank Details include specifics related to each of the ballast
tanks subject to monitoring. The tank details include water chemistry,
volume, pump activity, flow rate, etc. Also included are values determined
depending on the GPS data and the tank data to indicate to the ship crew
information such as a window of opportunity to comply with a full ballast
exchange, etc.
open window “Tank Details”
set position of window “Tank Details” to {4, 42}
--color codes for chemical probe indicator
set NOBOBColor to 1
set indeterminalColor to 166
set FreshColor to 35
set coastalColor to 5
set twentyfiveColor to 25
set fiftyColor to 80
set seventyfiveColor to 14
set onehundredColor to 113
--sets up the tank details to simulate conditions of each of six tanks
set fill color of box “boxCode1” of window “tank details” to
NOBOBColor
set fill color of box “boxCodeIndeterminable” of window “tank details” to
indeterminalColor
set fill color of box “boxCode2” of window “tank details” to FreshColor
set fill color of box “boxCode3” of window “tank details” to coastalColor
set fill color of box “boxCode4” of window “tank details” to
twentyfiveColor
set fill color of box “boxCodeS” of window “tank details” to fiftyColor
set fill color of box “boxCode6” of window “tank details” to
seventyfiveColor
set fill color of box “boxCode7” of window “tank details” to
onehundredColor
set fill color of box “boxTank1” of window “tank details” to FreshColor
set fill color of box “boxTank2” of window “tank details” to
indeterminalColor
set fill color of box “boxTank3” of window “tank details” to
onehundredColor
set fill color of box “boxTank4” of window “tank details” to
NOBOBColor
set fill color of box “boxTankS” of window “tank details” to FreshColor
set fill color of box “boxTank6” of window “tank details” to coastalColor
    --for prototype simluate a window of opportunity based on
the tank contents. In practice, the window of opportunity will
be calculated on-the-fly based on pump efficiency history. If
the system notices a drop in a particular pump's efficiency, a
maintanence signal can be transmitted to the crew and to the ship
owner or agent. The compliance of a full exchange is indicated
by factors such as water chemistry, volume of water that flows
through tank, etc. Two or more factors can be used to increase
consistency and correctness of the determination of a complete
exchange.
set contents of textbox “txtWindowofOp” of window “tank details” to
“WINDOW OF OPPORTUNIlY”
set contents of textbox “txtCountDown” of window “Tank Details” to
“2days 18hrs”
set visible of textbox “txtCanBeDischarged” of window “tank details”
to false
set visible of label “IbICompliance” of window “tank details” to false
set visible of textbox “txtBallastCannot” of window “tank details” to true
set contents of textbox “txtWindowofOpCoast” of window “tank details”
to
“WINDOW OF OPPORTUNITY”
set contents of textbox “txtCountDownCoast” of window “Tank Details”
to
“1day 22hrs”
set visible of textbox “txtCanBeDischargedCoast” of window
“tank details” to
false
set visible of label “IbIComplianceCoast” of window “tank details” to
false
set visible of textbox “txtBallastCannotCoast” of window “tank
details” to true
--window Ballast Exchange is the prototype screen for the Fresh
Water containing ballast tank number 5
open window “Ballast Exchange”
set position of window “Ballast Exchange” to {612, 40}
set fill color of window “Ballast Exchange” to FreshColor
end run
Code for pushbutton “Demo” of window “Ballast Exchange”.
The prototype software includes other actions taken in response to use of
interface screens and buttons, but for brevity these pieces of code.
This piece of software code demonstrates the detection of pump turning
on as an indication of when a possible exchange is occurring and the
salinity as an indication of a completed ballast exchange:
on hilited theObj
--configure the input/output device
configure ADBIO unit 1 port A as {digital out, digital out, digital out,
digital out}
configure ADBIO unit 1 port B as {analog in, analog in, analog in,
analog ref}
set ADBIO unit 1 port A channel 2 to low
--gauges that indicate pump activity
set visible of gauge “gagPump5” of window “Tank Details” to false
set visible of gauge “gagPump6” of window “Tank Details” to false
set visible of gauge “gagPumps” of window “Tank Details” to false
--color codes for chemical probe indicator
set NOBOBColor to 1
set indeterminalColor to 166
set FreshColor to 35
set coastalColor to 5
set twentyfiveColor to 25
set fiftyColor to 80
set seventyfiveColor to 14
set onehundredColor to 113
--this version is for no GPS connection
--set the text for Start of Exchange
set contents of label “IbILatEnd” to “ ”
set contents of label “IbILogEnd” to “ ”
set contents of label “IbITimeAtEnd” to “ ” as string
set contents of label “IbIBearing” to “ ” as string
set contents of label “IbIDistance” to “ ” as string
  (*range of prototype salt probe detection using ADBIO and circuit is
about 175 for fresh water and about 95 for open ocean water (the detection
circuit is an adjustable voltage regulator with the variable resistance
that determines the voltage being supplied by the varying conductivity of
the ballast water) *)
set y to 170 --upper range of guage and range of fresh water reading
set scroll of gauge “gagSalinity” to y
set x to 0
set contents of textbox “txtName3” to x --loop counter
repeat 40 times --do loop x times
WaitTicks (60)
idle
set contents of textbox “txtName3” to x
set x to (x + 1)
--detect if pump is energized (pump switch is sensed at port B channel
set pumpEnergized to value of (get ADBIO unit 1 port B channel
idle
if pumpEnergized = 0 then
idle
set contents of textbox “txtPumpIndicator” to “pump is idle”
set visible of gauge “gagPump5” of window “Tank Details” to false
else
idle
--in practice, the actual start time will be determined from clock
set contents of label “IbITimeAtStart” to “Monday, July 15, 2002
10:23AM”
idle
set contents of label “IbILatStart” to “41.3945”
idle
set contents of label “IbILogStart” to “−71.0165”
idle
set contents of textbox “txtWindowofOp” of window “Tank Details” to
“Estimated time until exchange complete:”
idle
set contents of textbox “txtCountDown” of window “Tank Details” to
“3 hours”
idle
set visible of textbox “txtCanBeDischarged” of window “tank details” to
false
idle
set visible of label “IbICompliance” of window “tank details” to false
idle
set visible of textbox “txtBallastCannot” of window “tank details” to true
idle
set contents of textbox “txtPumpIndicator” to “pump is energized”
idle
set visible of gauge “gagPumps” of window “Tank Details” to true
idle
set setting of gauge “gagPumps” of window “Tank Details” to 100
--if pump is energized, start detecting salinity
--y is the ADBIO input value from salinity probe
set contents of textbox “txtMessage” of window “Tank Details” to y as
string
--shows change
set y to value of (get ADBIO unit 1 port B channel 2)
set scroll of gauge “gagSalinity” to y
--tank5 is the prototype demonstration tank, as the salinity increases, the
interface colors change to give a visual indication of the status of the
tank being
exchanged
if (170 is greater than or equal to y and 150 is less than or equal to y)
then
idle
set fill color of box “boxTank5” of window “Tank Details” to FreshColor
--show fresh water color
idle
set fill color of window “Ballast Exchange” to FreshColor
idle
set fill color of box “boxCurrentChem” of window “Tank5” to FreshColor
idle
set contents of textbox “txtTankComp” of window “Tank Details” to
“Fresh”
else if (149 is greater than or equal to y and 130 is less than or equal
to y) then
idle
set fill color of box “boxTank5” of window “Tank Details” to
twentyfiveColor
idle
set fill color of window “Ballast Exchange” to twentyfiveColor
idle
set fill color of box “boxCurrentChem” of window “Tank5” to
twentyfiveColor
idle
set contents of textbox “txtTankComp” of window “Tank Details” to
“25%”
else if (129 is greater than or equal to y and 110 is less than or equal
to y) then
idle
set fill color of box “boxTank5” of window “Tank Details” to fiftyColor
idle
set fill color of window “Ballast Exchange” to fiftyColor
idle
set fill color of box “boxCurrentChem” of window “Tank5” to fiftyColor
idle
set contents of textbox “txtTankComp” of window “Tank Details” to
“50%”
else if (109 is greater than or equal to y and 100 is less than or equal
to y) then
idle
set fill color of box “boxTank5” of window “Tank Details” to
seventyfiveColor
idle
set fill color of window “Ballast Exchange” to seventyfiveColor
idle
set fill color of box “boxCurrentChem” of window “Tank5” to
seventyfiveColor
idle
set contents of textbox “txtTankComp” of window “Tank Details”
to “5%”
else if (99 is greater than or equal to y and 90 is less than or equal to
y) then
idle
set fill color of box “boxTank5” of window “Tank Details” to
onehundredColor
idle
set fill color of window “Ballast Exchange” to onehundredColor
idle
set fill color of box “boxCurrentChem” of window “Tank5” to
onehundredColor
idle
set contents of textbox “txtTankComp” of window “Tank Details”
to “100%”
idle
set visible of label “IbICompliance” of window “Tank Details” to true
set visible of textbox “txtCanBeDischarged” of window “tank details” to
true
set visible of textbox “txtBallastCannot” of window “tank details” to false
set visible of textbox “txtCountDown” of window “tank details” to false
idle
set contents of textbox “txtWindowofOp” of window “Tank Details” to
“THIS TANK IS IN COMPLIANCE WITH REGULATIONS”
idle
set contents of textbox “txtCountDown” of window “Tank Details” to “ ”
end if
if y < 99 then
idle
set ADBIO unit 1 port A channel 2 to high
set ADBIO unit 1 port A channel 3 to high
WaitTicks (15)
set ADBIO unit 1 port A channel 3 to low
else
set ADBIO unit 1 port A channel 2 to low
end if
end if
end repeat
--blackbox includes a beeper that indicates when an exchange is completed
set ADBIO unit 1 port A channel 3 to high
WaitTicks (15)
set ADBIO unit 1 port A channel 3 to low
WaitTicks (15)
set ADBIO unit 1 port A channel 3 to high
WaitTicks (15)
set ADBIO unit 1 port A channel 3 to low
WaitTicks (15)
set ADBIO unit 1 port A channel 3 to high
WaitTicks (15)
set ADBIO unit 1 port A channel 3 to low
WaitTicks (15)
set ADBIO unit 1 port A channel 3 to high
WaitTicks (15)
set ADBIO unit 1 port A channel 3 to low
WaitTicks (15)
set ADBIO unit 1 port A channel 3 to high
WaitTicks (60)
set ADBIO unit 1 port A channel 3 to low
--channel 2 is connected with pump indicator light
set ADBIO unit 1 port A channel 2 to low
set visible of gauge “gagPump5” of window “Tank Details” to false
--use this for non-GPS demo
--set the text for end of Exchange
set contents of label “IbILatEnd” to “42.0123”
set contents of label “IbILogEnd” to “−70.9876”
set contents of label “IbITimeAtEnd” to “Monday, July 15, 2002
10:25AM”
set contents of label “IbIBearing” to “233.9 (mag)” as string
set contents of label “IbIDistance” to “237 Nautical Miles” as string
end hilited
```

1) A system for tracking the exchange of ballast water in the ballast water tank of a ship, comprising: a chemistry detector for detecting the chemical composition of ballast water contained within a ballast water tank of a ship; chemistry change determining means for determining a change in chemistry of the ballast water and for determining a level of completeness of a ballast water exchange dependent on the change in chemistry; geographic location determining means for determining a geographic location of the ship when the determined change in chemistry reaches a predetermined threshold level; storage means for storing data dependent on the determined change in chemistry and the determined geographic location; uploading means for uploading the stored data to a data collection device; and controlling means for receiving a signal from the chemistry change determining means indicating the change in chemistry and for controlling the geographic location determining means, the storing means and the uploading means; whereby the change in chemistry of ballast water within the ballast tank of the ship can be tracked to determine a ballast exchange and the completeness of the ballast exchange, and a record ballast water exchange based on the change in chemistry and the geographic location of the ship during the change can be uploaded to the data collection device.

2) A system for tracking the chemistry of ballast water in the ballast water tank of a ship according to claim 1; further comprising a pump operation detector for detecting when a pump used to perform the ballast water exchange is operating.

3) A system for tracking the chemistry of ballast water in the ballast water tank of a ship according to claim 1; wherein the geographic location determining means comprises a GPS system for determining the geographic location.

4) A system for tracking the chemistry of ballast water in the ballast water tank of a ship according to claim 1; wherein the storage means comprises a random access memory device.

5) A system for tracking the chemistry of ballast water in the ballast water tank of a ship according to claim 1; wherein the uploading means comprises a radio transmitter for transmitting the stored data.

6) A system for tracking the chemistry of ballast water in the ballast water tank of a ship according to claim 1; wherein the uploading means comprises a satellite radio transmitter for transmitting the stored data at at least one of predetermined times or in response to the determined change in chemistry reaching the predetermined threshold level.

7) A system for tracking the chemistry of ballast water in the ballast water tank of a ship according to claim 1; wherein the uploading means comprises a radio transmitter for transmitting the stored data when the geographic location of the ship reaches a predetermined determined location.

8) A system for tracking the chemistry of ballast water in the ballast water tank of a ship according to claim 1; wherein the uploading means includes a signal range detector for detecting when the ship is within transmission range of a receiver for uploading the stored data.

9) A system for tracking the chemistry of ballast water in the ballast water tank of a ship according to claim 8; wherein the uploading means comprises a cellular telephone, and the receiver comprises a cellular phone signal receiving station.

10) A system for tracking the chemistry of ballast water in the ballast water tank of a ship according to claim 1; wherein the uploading means comprises means for formatting the stored data for transmission over the Internet, and wherein the data collection device comprises a remotely located Internet server.

11) A system for tracking the chemistry of ballast water in the ballast water tank of a ship according to claim 1; wherein the controlling means comprises a microprocessor.

12) A method for tracking the chemistry of ballast water in the ballast water tank of a ship, comprising the steps of: detecting the salt content of ballast water contained within a ballast water tank of a ship; determining a change in chemistry of the ballast water; determining a geographic location of the ship when the determined change in chemistry reaches a predetermined threshold level; storing data dependent on the determined change in chemistry and the determined geographic location; uploading the stored data to a data collection device, whereby the change in chemistry of ballast water within the ballast tank of the ship can be tracked and a record of the change in chemistry and the geographic location of the ship during the change can be uploaded to the data collection device.

13) A method for tracking the chemistry of ballast water in the ballast water tank of a ship according to claim 12; wherein the step of detecting the salt content of ballast water includes using a chemistry probe comprising a pair of electrodes inserted in the ballast water and a current change detector for detecting the change in chemistry dependent on the change in current flow through the ballast water between the pair of electrodes.

14) A method for tracking the chemistry of ballast water in the ballast water tank of a ship according to claim 12; wherein the step of determining the geographic location comprises using a GPS system for determining the geographic location.

15) A method for tracking the chemistry of ballast water in the ballast water tank of a ship according to claim 12; wherein the step of uploading the stored data comprises using a radio transmitter for transmitting the stored data.

16) A method for tracking the chemistry of ballast water in the ballast water tank of a ship according to claim 1; wherein the step of uploading the stored data comprises using a satellite radio transmitter for transmitting the stored data at at least one of predetermined times or in response to the determined change in chemistry reaching the predetermined threshold level.

17) A method for tracking the chemistry of ballast water in the ballast water tank of a ship according to claim 12; wherein the step of uploading the stored data comprises using a radio transmitter for automatically transmitting the stored data when the geographic location of the ship reaches a predetermined location.

18) A method for tracking the chemistry of ballast water in the ballast water tank of a ship according to claim 12; wherein the step of uploading the stored data includes using a signal range detector for detecting when the ship is within transmission range of a receiver for uploading the stored data.

19) A method for tracking the chemistry of ballast water in the ballast water tank of a ship according to claim 18; wherein the step of uploading the stored data comprises using a cellular telephone system for automatically uploading the stored data when the ship comes with signal range of a cellular phone signal receiving station.

20) A method for tracking the chemistry of ballast water in the ballast water tank of a ship according to claim 12; wherein the step of uploading the stored data includes the step of formatting the stored data for transmission over the Internet, and wherein the data collection device comprises a remotely located Internet server.

21) A method for tracking the chemistry of ballast water in the ballast water tank of a ship according to claim 20; further comprising the step of receiving the Internet formatted stored data via an Internet connection and storing the Internet formatted stored data at an Internet web site.

22) A method for tracking the exchange of ballast water in the ballast water tank of a ship, comprising the steps of: detecting a change in the chemical composition of ballast water onboard a ship during a voyage; determining a geographical location of the detection of the change in the chemical composition of the ballast water; recording the detected change in the chemical composition of the ballast water and the determined geographical location so that a record can be made of the detected change and the geographical location of the detected change for tracking the exchange of ballast water in the ballast water tank of the ship.

23). A method for tracking the exchange of ballast water according to claim 22; wherein the step of detecting the change in the chemical composition comprises detecting a change in a salt concentration of the ballast water.

24). A method for tracking the exchange of ballast water according to claim 23; wherein the change in the salt concentration is detected by detecting a change in electrical properties of the ballast water.
